(19) United States
(12) Patent Application Publication
(10) Pub. No.: US 2025/0141510 A1
(43) Pub. Date: May 1, 2025

(54) Method and Apparatus for Transmit Beamforming

(71) Applicant: ViaSat, Inc., Carlsbad, CA (US)

(72) Inventor: Michail K. Tsatsanis, Huntington Beach, CA (US)

(21) Appl. No.: 18/838,645

(22) PCT Filed: Feb. 18, 2022
(86) PCT No.: PCT/US2022/017054

§ 371 Date: Aug. 15, 2024

(51) Int. Cl. H04B 7/06; H04W 52/36

(52) U.S. Cl. CPC H04B 7/0617; H04B 7/0626; H04B 7/0634; H04W 52/367

(57) ABSTRACT

A technique determines a transmit beamforming vector for multi-lobe beamforming of a signal that is transmitted in common—multicast—for a corresponding group of receivers. The multiple lobes correspond to the spatial distribution of receivers within the population. The technique, which may be referred to as multi-lobe or group-based beamforming and which may be used with a single group or with multiple groups, relies on an advantageous iterative update procedure that revises the transmit beamforming vector(s) in dependence on identifying a representative receiver in each group of receivers. In particular, the iterative revisions include incremental changes calculated to improve received-signal quality for the representative receiver(s). When there are two or more groups, the technique accounts for mutual interference between the per-group signals being beamformed. Each group of receivers may be referred to as a “population.”

### TECHNICAL FIELD

Apparatus and methods disclosed herein relate to beamforming for the transmission of electromagnetic signals, such as from a satellite to terrestrial terminals, and relate in particular to iterative beamforming.

### BACKGROUND

“Beamforming” of electromagnetic signals refers to directional signal transmission or reception from an antenna, with “direction” referring to horizontal or vertical angles relative to the involved antenna. Beamforming a signal for transmission involves controlling the phase and amplitude of the signal from a plurality of antenna elements, to create a pattern of constructive and destructive interference in the resulting wavefront radiated from the antenna, with the pattern forming a beam of signal energy in the far field.

A beamformer can be understood as “converting” between beam signals and element signals, where a “beam signal” represents a signal to be transmitted or received with a particular directional sensitivity, and where each element signal is a respectively weighted version of the beam signal corresponding to a particular one of the antenna elements of the antenna used for beamforming. The weightings, referred to as beamforming coefficients, comprise respective delays that cause the desired directionality via corresponding patterns of constructive and destructive combining.

Beamforming in a “unicast” transmission scenario involves beamforming a transmit signal targeting an individual receiver, so that the beamforming gain increases received-signal quality at the individual receiver. Assuming that the transmitter has the capability of concurrent beamforming of multiple unicast signals, it may transmit different beamformed unicast signals concurrently, each one targeting a different receiver and each one transmitted according to beamforming coefficients computed for the corresponding receiver. Ideally, the beamforming vectors (or collections of beamforming coefficients) computed for these multiple receivers maximize the strength of the intended signal at each receiver and minimize interference caused by that signal with respect to the remaining receivers.

Certain beamforming scenarios introduce significant complexity with respect to determining the beamforming solution(s). Here, the term “beamforming solution” refers to the beamforming vector(s) used for transmit beamforming. In turn, a “beamforming vector” is the set of beamforming coefficients used to transmit a signal with different weightings from each among a plurality of antenna elements.

Multicasting distinguishes from unicasting in that the signal is intended for a group of users, with the same signal being transmitted for each user in the group. Multicasting has applicability in a wide variety of communication scenarios where there are defined groups of users “interested” in receiving the same signal. For example, a known group of receivers may be interested in receiving the same signal, such as a software update common to the group, or media content, such as one or more movies. Here, “group” does not necessarily connote a tight geographic grouping and instead refers to users that define a group in the sense that they are all intended to receive a particular broadcast or multicast transmission.

### SUMMARY

A technique determines a transmit beamforming vector for multi-lobe beamforming of a signal that is transmitted in common—multicast—for a corresponding group of receivers. The multiple lobes correspond to the spatial distribution of receivers within the population. The technique, which may be referred to as multi-lobe or group-based beamforming and which may be used with a single group or with multiple groups, relies on an advantageous iterative update procedure that revises the transmit beamforming vector(s) in dependence on identifying a representative receiver in each group of receivers. In particular, the iterative revisions include incremental changes calculated to improve received-signal quality for the representative receiver(s). When there are two or more groups, the technique accounts for mutual interference between the per-group signals being beamformed. Each group of receivers may be referred to as a “population.”

An example embodiment comprises a method performed for transmit beamforming. The method comprises revising a transmit beamforming vector for multi-lobe beamforming of a signal for a population of receivers, with the revising performed according to an iterative update procedure. Each iteration of the iterative update procedure comprises selecting a representative receiver among the population of receivers, based on received-signal quality estimates for the receivers in the population, the received-signal quality estimates dependent upon the transmit beamforming vector; and further comprises revising the transmit beamforming vector, according to an incremental change that is calculated to improve received-signal quality at the representative receiver.

The method further includes terminating the iterative update procedure responsive to fulfillment of a termination condition and applying the transmit beamforming vector to the beamforming of the signal. In at least one embodiment, the method includes determining a beamforming solution comprising a transmit beamforming vector for each population of receivers, among two or more populations of receivers, and the iterative update procedure accounts for mutual interference between the signals targeted to the respective populations when calculating the incremental changes to the respective transmit beamforming vectors.

Another example embodiment comprises a beam updater circuit comprising processing circuitry and interface circuitry. The processing circuitry is configured to revise a transmit beamforming vector for multi-lobe beamforming of a signal for a population of receivers. The revising is performed according to an iterative update procedure in which each iteration comprises the processing circuitry selecting a representative receiver among the population of receivers, based on received-signal quality estimates for the receivers in the population, the received-signal quality estimates dependent upon the transmit beamforming vector. The iteration continues with the processing circuitry revising the transmit beamforming vector, according to an incremental change that is calculated to improve received-signal quality at the representative receiver.

The processing circuitry is configured to terminate the iterative update procedure responsive to fulfillment of a termination condition and apply the transmit beamforming vector to the beamforming of the signal. For example, the processing circuitry applies the transmit beamforming vector by outputting signaling to the involved transmission system, via the interface circuitry. In at least one embodiment, the beam updater circuit determines a beamforming solution comprising a transmit beamforming vector for each population of receivers, among two or more populations of receivers, and the iterative update procedure accounts for mutual interference between the signals targeted to the respective populations when calculating the incremental changes to the respective transmit beamforming vectors.

Another example embodiment comprises a transmission system. The transmission system includes a beamforming system configured to beamform a signal for a population of receivers. The transmission system further includes a beam updater circuit that is configured to revise a transmit beamforming vector for beamforming of the signal by the beamforming system.

The beam updater circuit of the transmission system includes processing circuitry and interface circuitry. The processing circuitry is configured to revise the transmit beamforming vector. The revising is performed according to an iterative update procedure in which each iteration comprises the processing circuitry selecting a representative receiver among the population of receivers, based on received-signal quality estimates for the receivers in the population, the received-signal quality estimates dependent upon channel state information and the transmit beamforming vector. The iteration continues with the processing circuitry revising the transmit beamforming vector, according to an incremental change that is calculated to improve received-signal quality at the representative receiver.

The processing circuitry is configured to terminate the iterative update procedure responsive to fulfillment of a termination condition and apply the transmit beamforming vector to the beamforming of the signal. For example, the processing circuitry applies the transmit beamforming vector by outputting signaling to the involved transmission system, via the interface circuitry.

The transmission system is comprised in a satellite communication system in one or more embodiments. The satellite communication system in one or more embodiments is configured for ground-based beamforming (GBBF), and the transmission system spans a ground segment of the satellite communication system and a satellite of the satellite communication system. The satellite communication system in one or more other embodiments is configured for satellite-based beamforming, and the transmission system comprises a payload of the satellite.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIGS. 1A and 1B are block diagrams of a beam updater circuit for a transmission system that performs transmit beamforming, according to an example embodiment.

FIG. 2 is a block diagram of a satellite communication system that includes a beamforming transmission system according to an example embodiment.

FIG. 3 is a block diagram of a satellite according to an example embodiment.

FIG. 4 is a block diagram of a satellite communication system that includes a beamforming transmission system according to another example embodiment.

FIGS. 5A and 5B are block diagrams illustrating example details for initializing a transmit beamforming vector according to an example embodiment.

FIG. 6 is a logic flow diagram of a method of revising a transmit beamforming vector according to an iterative update procedure, according to an example embodiment.

FIGS. 7-9 are diagrams of example vector spaces associated with transmit beamforming and illustrate approaches to identifying a representative receiver and calculating an incremental change for a transmit beamforming vector, according to example embodiments.

FIG. 10 is a logic flow diagram of a method of revising a transmit beamforming vector according to an iterative update procedure and can be understood as the method of FIG. 6 applied to a broadcasting example involving a single population of receivers.

FIG. 11 is a logic flow diagram of a method of revising multiple transmit beamforming vectors according to an iterative update procedure and can be understood as the method of FIG. 6 applied to a multicasting example involving multiple populations of receivers.

FIG. 12 is a block diagram of a transmission system according to another example embodiment.

FIGS. 13-15 are diagrams of example performance results obtained using transmit beamforming according to an example embodiment.

### DETAILED DESCRIPTION

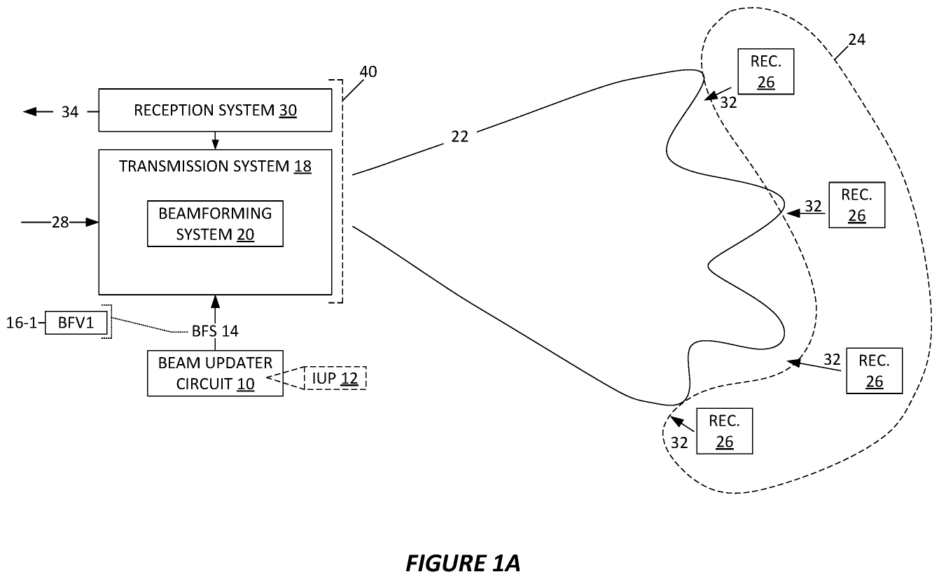

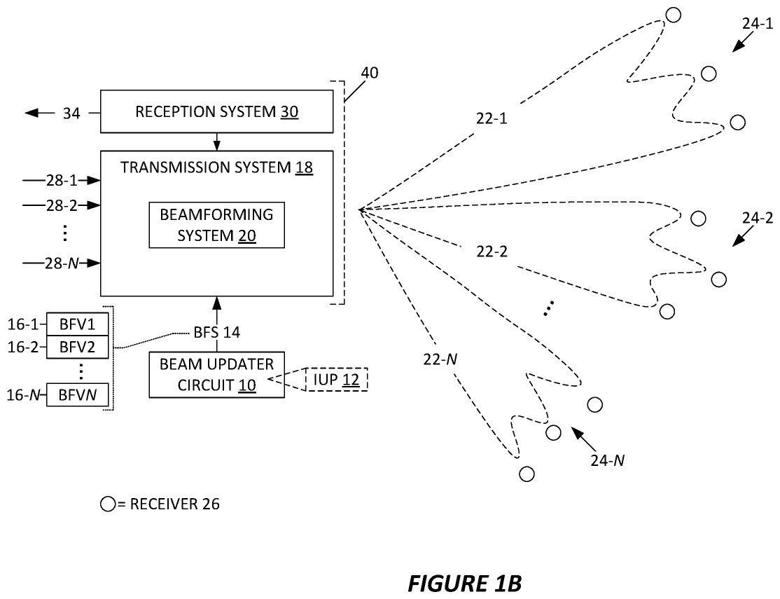

FIG. 1A illustrates a beam updater circuit 10 that performs an advantageous iterative update procedure (IUP) 12 to determine a beamforming solution (BFS) 14 comprising one or more beamforming vectors (BFVs) 16. The beam updater circuit 10 applies the BFS 14 by providing it to a transmission system 18 that includes a beamforming system 20 that performs beamforming according to the BFS 14. The BFS 14 includes a BFV 16 for each of one or more beamformed signals 22 transmitted by the transmission system 18.

Each beamformed signal 22 provides traffic—data—for a respective population 24 of receivers (“REC.”) 26, and the transmission system 18 generates or receives a beam signal 28 carrying the traffic to be transmitted as a corresponding one of the beamformed signals 22. The transmission system 18 may transmit a single beamformed signal 22 for a single population 24 of receivers 26, or it may transmit a different beamformed signal 22 for each population 24 among a plurality of populations 24.

FIG. 1A depicts the former circumstances, where there is one population 24 of receivers 26 targeted by a beam signal 28 that carries information common to all receivers 26 in the population 24, and where the beamformed signal 22 conveys that beam signal 28. As an example, the beamforming system 20 duplicates the beam signal 28 K times, for K transmit antenna elements, and applies a set of K per-element beamforming weights to the K copies of the beam signal 28 to obtain a set of K element signals. Transmission of the K element signals from the respective transmit antenna elements produces the beamformed signal 22 in the far field.

One aspect of the beamforming is that the receivers 26 constituting the population 24 need not be co-located or necessarily clustered together in a geographic sense, because the IUP 12 can be understood as implementing a type of group-based approach to beamforming that, over one or more cycles, adjusts the BFS 14 such that it tends to form or accentuate far-field beam lobes that correspond to the respective locations of receivers 26, or clusters of receivers 26, within the overall population 24. In particular, the group-based beamforming embodied in the IUP 12, which also may be referred to as multi-lobe beamforming, forms or accentuates lobes in the directions of the weakest receivers 26 among a population 24.

For example, consider a defined threshold SNR that must be satisfied at each receiver 26 in the population 24, which may depend upon the Modulation and Coding Scheme (MCS) used for conveying the beam-signal information in the beamformed signal 22. Typically, some receivers 26 receive the beamformed signal 22 at an SNR comfortably above the threshold and in that respect the directions associated with such receivers 26 may be considered as having excess transmit power. Running the IUP 12, e.g., on a recurring basis, “shifts” excess power towards the receiver(s) 26 that are the weakest among the population 24. FIG. 1A suggests this multi-lobed characteristic of the beamformed signal 22, without necessarily depicting an actual radiation pattern.

Thus, the term “population” denotes a group of receivers 26 that are intended to receive the same beam signal 28, rather than necessarily denoting geographically-clustered receivers 26. The transmission system 18 multicasting the beam signal 28 comprises transmitting it according to a BFS 14 that yields a beamformed signal 22 that is shaped by the IUP 12 to account for the weakest receivers or receivers 26 in the population 24, which may change over time.

FIG. 1A also illustrates a reception system 30 that is integrated or otherwise associated with the transmission system 18, and it may be used to receive feedback from individual ones of the receivers 26. FIG. 1A denotes such feedback using the reference number “32” and the feedback comprises, for example, Channel State Information (CSI). Of course, the phrase “receiver 26” is one of convenience in the context of the beamforming at issue, and it should be understood that the receivers 26 may be transceivers and may transmit return data for reception by the reception system 30. In turn, the reception system 30 may output corresponding traffic signals 34, e.g., for routing to other subsystems or networks.

FIG. 1B illustrates a more general example, where there are N respective populations 24. Correspondingly, there are N beamformed signals 22-1 through 22-N, N beam signals 28-1 through 28-N, and N BFVs 16-1 through 16-N in the BFS 14.

Again, each beamformed signal 22 can be understood as carrying information to be multicast to a particular population 24 of receivers 26. Non-limiting examples of the traffic carried in each beam signal 28 is multimedia content to be received by all receivers 26 in a respective population 24, a software update file, or other data file(s).

Each beamformed signal 22 can be understood as the transmitted, beamformed version of a corresponding one of the beam signals 28 and, unlike the single-population scenario of FIG. 1A, the scenario illustrated in FIG. 1B raises “mutual interference” concerns. Particularly, in the single-population scenario, the IUP 12 need not worry about the beamformed signal 22 causing interference to receivers 26 in other populations 24, which means that the beamforming-solution adjustments determined by the IUP 12 are not constrained by mutual-interference considerations. Conversely, in the scenario of FIG. 1B, shaping of the beamformed signals 22-1, 22-2, through 22-N must consider mutual interference, which is the interference a beamformed signal 22 targeting one population 24 causes to receivers 26 in other populations 24.

The IUP 12 accounts for the mutual interference problem by making adjustments to the BFVs 16 that form the BFS 14 on a “joint” basis—e.g., considering the effects of mutual interference when determining how to adjust the BFS 14 to improve signal quality at the weakest receivers 26 in the respective populations 24. Here, it should be appreciated that the receivers 26 within any given population 24 may be dispersed and even mixed with the receivers of other populations, as long as receivers from different populations do not occupy the same location. A more precise way to express this restriction is to say that the performance of the system degrades the closer two terminals from different populations are placed. The case of geographically intermixed terminals from different populations is not shown in FIG. 1B for reasons of clarity of presentation.

Operations performed by the transmission system 18 include link adaptation, wherein the transmission system 18 adapts one or more transmission parameters used for transmission of each beam signal 28 in dependence on reception conditions experienced by the respective population 24 of receivers 26. Link adaptation accommodates the “weakest” receiver 26 in the respective population 24, meaning that transmission parameters of the beam signal 28 for that population 24 are controlled to yield a required minimum signal quality—e.g., a minimum required signal-to-noise ratios (SNR) or signal-to-interference-and-noise ratio (SINR)—at the weakest receiver 26 in the respective population 24.

As an example, a lower-order of modulation or a higher coding rate may be used for multicasting the beam signal 28 to the population 24, to accommodate the weakest receiver 26 in the population 24. That change necessarily applies to all other receivers 26 in the population 24, even the ones that could support higher-order modulation or lower coding rates. As a consequence of this type of link adaptation, achievable throughput for each beam signal 28 is a function of the weakest receiver 26 in the respective population 24—i.e., the receiver 26 experiencing the worst reception conditions.

As noted, a reception system 30 integrated in or associated with the transmission system 18 provides the transmission system 18 with a mechanism for monitoring the reception conditions at individual receivers 26 within each population 24. For example, each receiver 26 sends information about reception conditions at the receiver 26, such as by reporting CSI. CSI includes, for example, estimates of the transmission channel between the receiver 26 and the antennas of the transmission system 18 being used for beamforming. As an additional example, CSI may also include noise level and/or interference level at the receiver. The reference number “32” in the diagram collectively indicates the feedback from the individual receivers 26 in each population 24.

The transmission system 18 comprises one or more transmitters, with each such transmitter comprising circuitry and corresponding antennas. In at least one embodiment, a node of a communication network implements the transmission system 18, with the node being a terrestrial node or an airborne or spaceborne node. In at least one embodiment, the node also integrates the reception system 30, which comprises one or more receivers, with each such receiver comprising circuitry and corresponding antennas.

In other embodiments, the transmission system 18 comprises two or more transmitters with radio links between them, e.g., where an overall transmission “path” includes the link from a first transmitter to a second transmitter, and the link from the second transmitter to the targeted receiver(s) 26, with the second transmitter acting as a relay node. Similarly, the reception system 30 may include two or more receivers that are wirelessly linked. In any case, the transmission system 18 and the reception system 30 together comprise a transceiver system 40 that comprises one or more transceiver nodes. In FIGS. 1A and 1B, in addition to transmitting “forward” traffic to the receivers 26, the transceiver system 40 may provide for the reception of traffic-data signals—from individual receivers 26 in the respective populations, with such traffic being output as traffic signals 34 from the reception system 30, e.g., for transport to an external network, such as the Internet or the Public Switched Telephone Network (PSTN).

The term “system” herein denotes a set of physical things working together, such as transmit circuitry outputting amplified signals into corresponding antenna feeds for transmission from corresponding transmit antennas. As such, a single, self-contained transmit node in a communication network constitutes an example “system,” as would two or more transmit nodes working cooperatively. Operation of any such system may be controlled at least in part by the execution of computer program instructions by one or more processors included in the system.

The term “population” refers to a group of receivers 26 that are the logical targets of a given beamformed signal 22. “Receiver” in this context is a label of convenience, denoting a device or system operative to receive the type(s) of signals transmitted by the transmission system 18—e.g., in terms of signal frequencies, structure, protocol, etc. Further, each receiver 26 may be a transceiver operative for both reception of signals from the transmission system 18 and transmission of signals for the reception system 30. Thus, while this disclosure generally refers to “receivers 26,” other terms are interchangeable, with these other terms including transceiver devices, wireless transmit/receive units (WTRUs), subscriber devices, subscriber terminals, or user terminals (UTs). The terms user terminals or subscriber terminals emphasize that the receivers 26 in one or more embodiments are used to obtain communication services on a subscription basis, with those services provided via a communication network that includes the transceiver system 40.

The IUP 12 performed by the beam updater circuit 10 addresses a number of beamforming challenges, including addressing the weakest-receiver problem described above. Performance of the IUP 12 yields a BFS 14, which may be an update of an existing BFS 14. As noted above, the BFS 14 comprises a BFV 16 which enables each beam signal 28 to be transmitted by the transmission system 18. Each BFV 16 comprises a set of beamforming coefficients, also referred to as beamforming weights.

Each beamforming weight corresponds to one among the set of antennas used for transmit beamforming, with each beamformed signal 22 “formed” in the far field by transmitting a different weighted version of the same beam signal 28 from each of the antennas. Each beamforming coefficient may comprise a complex value having a phase or delay component and an amplitude component. The beam updater circuit 10 applies the BFS 14 by providing it to the transmission system 18 or otherwise causing the beamforming system 20 to use the BFS 14 in its transmission of the one or more beam signals 28.

In one example, the beam updater circuit 10 applies the BFS 14 as yielded by the IUP 12 by sending signaling to the beamforming system 20, which causes the beamforming system 20 to adopt the beamforming weights comprised in the BFS 14, for transmission of the beam signals 28 represented in the BFS 14. Note that the transmission system 18 may operate with an existing BFS 14, while the beam updater circuit 10 computes an updated version of the BFS 14, via the IUP 12.

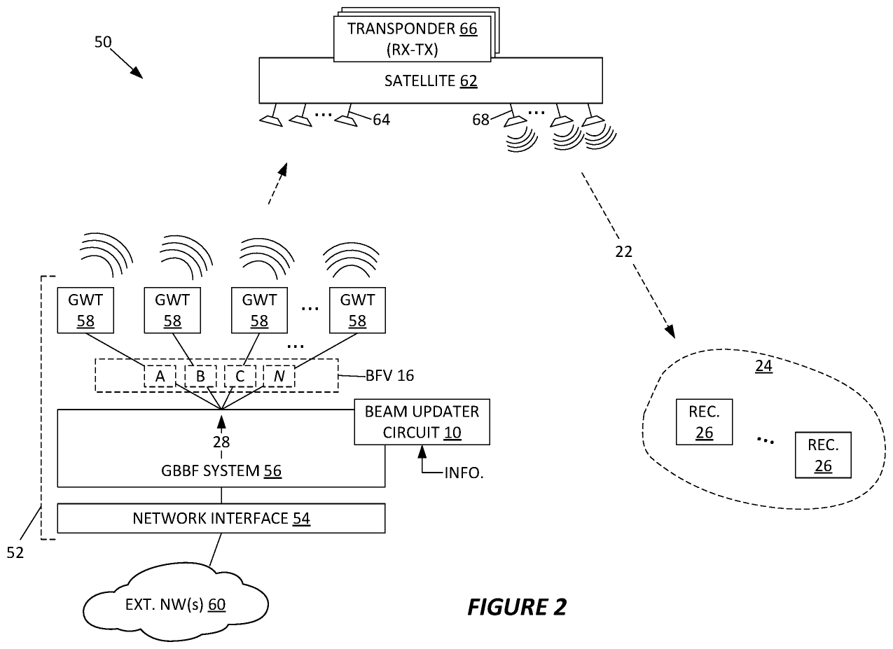

FIG. 2 illustrates an example embodiment based on a satellite communication system 50 that uses ground-based beamforming (GBBF) to serve one or more populations 24 of receivers 26 with respective beamformed signals 22. For simplicity of illustration, in FIG. 2 and in certain other figures, the beamformed signal 22 appears as a directional arrow rather than a shaped, multi-lobe wavefront. Further, only one population 24 served by one beamformed signal 22 is shown for convenience of discussion. As described for FIGS. 1A and 1B, the beamformed signal 22 is a beamformed version of a beam signal 28 that carries the traffic targeted to the involved population 24 of receivers 26, and it may be understood as a group-based or multi-lobed beamformed signal that is shaped according to the beamforming goals embodied in the IUP 12.

The satellite communication system 50 includes a ground segment 52 that includes a network interface 54, a GBBF system 56, and a plurality of geographically-separated gateway terminals 58, where “GWT” abbreviates “gateway terminal” in the diagram. The satellite communication system 50 communicatively couples the receivers 26 with one or more external networks 60, such as the Internet or the Public Switched Telephone Network (PSTN).

To produce the beamformed signal 22 in the far field, relative to the population 24 of receivers 26, the GBBF system 56 sends the same beam signal 28 to each of the gateway terminals 58, and each gateway terminal 58 transmits the signal synchronously with the others but using a different beamforming weight. These operations are suggested in the diagram by showing a BFV 16 comprising different beamforming weights A, B, C, through N, to be applied by respective gateway terminals 58, for transmission of a beam signal 28. The example assumes N gateway terminals 58 cooperating in the transmission of the beam signal 28, where N is an integer greater than 1.

FIG. 2 depicts GBBF for a single broadcast beam. If two or more populations of receivers are present and two of more beams are formed, the GBBF system 52 will receive two or more information signals 28 from the external network 60 and the respective gateway terminals 58 will apply two or more BFVs 16 to the two or more information signals 28 (one per beam). Finally, the respective gateway terminals 58 will add the two or more signals and transmit the resulting signal superposition.

A satellite 62 of the satellite communication system 50 is configured, for example, as a bent-pipe satellite that relays radio signals from the ground segment 52 to the population 24 of receivers 26. The satellite 62 includes a plurality of receiver antennas 64, with each receive antenna 64 feeding into a corresponding transponder 66. Each transponder 66 comprises, for example, a non-processed radiofrequency (RF) signal path having receiver circuitry coupled with a corresponding one of the receiver antennas 64, and transmitter circuitry coupled with a corresponding one among a plurality of transmit antennas 68.

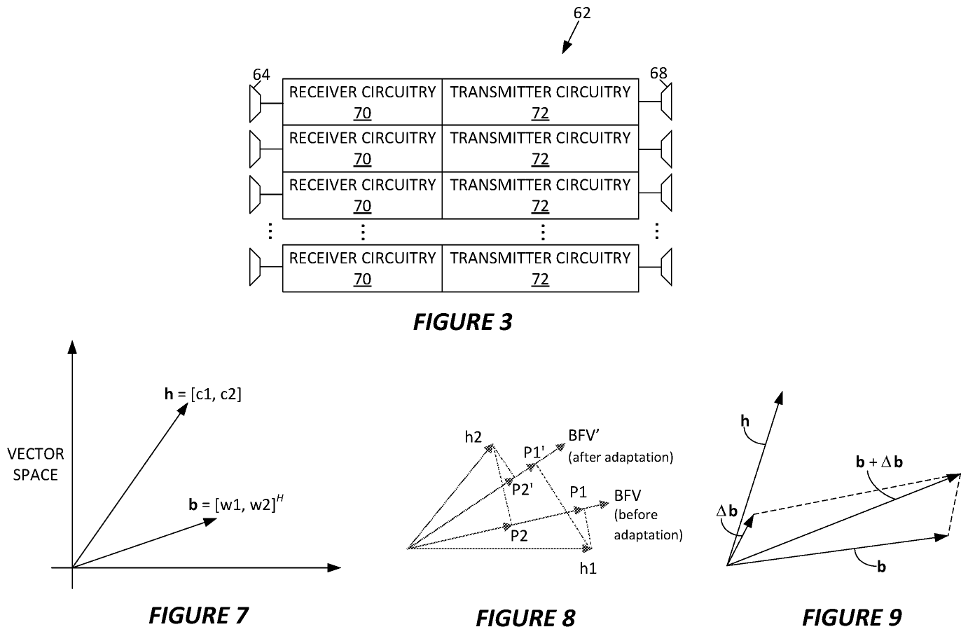

FIG. 3 depicts an example arrangement of the satellite 62, where each transponder 66 comprises receiver circuitry 70 and transmitter circuitry 72. In one or more embodiments, the receiver circuitry 70 or the transmitter circuitry 72 includes frequency-translation circuitry for shifting between uplink-carrier frequencies used by the gateway terminals 58 and downlink-carrier frequencies used by the satellite 62.

Each receiver antenna 64 receives a superposition of the weighted signals from two or more of the gateway terminals 58, such that each transponder 66 transmits a corresponding superposition of the weighted signals. By basing the BFV 16 used to weight transmission of the beam signal 28 from the set of gateway terminals 58 on knowledge of the relative phase delays and attenuations of the end-to-end paths from the gateway terminals 58 through the satellite 62 to the population 24 of receivers 26, the GBBF system 56 realizes the radiation pattern for the beamformed signal 22. For additional example details of GBBF operations, see U.S. Pat. No. 11,018,757 B2, issued on May 25, 2021.

FIG. 2 depicts the beam updater circuit 10 as being implemented as part of the GBBF system 56. Beam updating techniques disclosed herein are applicable in the GBBF scenario and also in other scenarios. One such other scenario is “payload” based beamforming, where the satellite provides the digital processing and waveform generation, for transmit beamforming by the satellite. Another such scenario is “hybrid GBBF,” where the waveforms to be transmitted by the satellite are calculated on the ground and transmitted to the satellite, e.g., using frequency-based multiplexing, with the satellite demultiplexing the waveforms for transmit beamforming.

Referring back to FIG. 1A or 1B, the GBBF system 56 together with the superposition-based transmission/reception arrangement of the gateway terminals 58 and the satellite transponders 66 can be understood as constituting an example transmission system 18. More generally, the GBBF system 56, the gateway terminals 58, and the satellite 62 represent an example of a transceiver system 40. In such an arrangement, a forward channel is based on radio uplinks from the gateway terminals 58 to the satellite 62 and radio downlinks from the satellite 62 to the receivers 26. Conversely, a return channel from each receiver 26 to the ground segment 52 is based on radio uplinks from the receivers 26 to the satellite 62 and radio downlinks from the satellite 62 to respective ones of the gateway terminals 58.

Information (“INFO.” in FIG. 2) is provided to or obtained by the beam updater circuit 10. The information comprises, for example, Channel State Information (CSI) for the individual receivers 26 in the population 24. The beam updater circuit 10 uses such information to compute the BFS 14 and it may perform such computations on an initial basis, or a recurring or triggered basis, e.g., to maintain an updated BFS 14 over some longer interval.

In an example arrangement, the beam updater circuit 10 receives CSI that is fed back from the population 24 of receivers 26 via the satellite 62 and the gateway terminal(s) 58. For each receiver 26, the CSI includes channel estimates that represent the end-to-end transmission channel from the ground segment 52 to the receiver 26.

The CSI may include SNR or SINR measurements or indications of such, such as a quantized measure of SNR/SINR conveyed as a Channel Quality Indicator (CQI). Each receiver 26 may perform channel estimation and received-signal quality estimation based on receiving reference signals over the same transmission channel used for transmission of the beam signal 28—i.e., per-antenna reference signals, such as pilot-symbol transmissions. If the CSI from the receivers 26 does not include estimates of received-signal quality, the beam updater circuit 10 in one or more embodiments is configured to derive such estimates from the CSI.

As an alternative to receiving CSI from the receivers 26, the beam updater circuit 10 in one or more embodiments derives CSI for each receiver 26 based on receiving information indicating the geographic locations of the receivers 26. Such information has particular relevance with respect to receivers 26 that are stationary, at least temporarily, and in precisely known geographic locations. Such information can be used to estimate the transmission channel for each receiver 26 in the population 24.

FIG. 4 illustrates another example embodiment, where the satellite communication system 50 uses satellite-based beamforming rather than ground-based beamforming. As such, the transponders 66 of the satellite 62 implement the beamforming system 20 introduced in FIGS. 1A and 1B, and the beam updater circuit 10 comprises part of the payload of the satellite 62. In this example, the satellite 62 comprises a transmission system 18 and a reception system 30, together operating as a transceiver system 40. The satellite 62 may be considered as an “end-to-end relay” in the sense that it relays traffic signals transmitted from the ground segment 52 to the receivers 26, and relays traffic signals transmitted from the receivers 26 back to the ground segment 52.

As a particular example, the satellite 62 receives an uplink signal 80 transmitted from a gateway terminal 58 for a population 24 of receivers 26. The uplink signal 80 comprises or includes a beam signal 28, for retransmission by the satellite 62 as a beamformed signal 22 targeted to a respective population 24 of receivers 26. Thus, the satellite 62 retransmits the beam signal 28 from a plurality of transmit antennas 68 according to the per-antenna weightings defined by a BFV 16 computed by the beam updater circuit 10. The per-antenna transmissions produce the beamformed signal 22 in the far field.

The satellite 62 may receive multiple beam signals 28 and perform corresponding beamforming for each one, according to respective BFVs 16. As noted, hybrid GBBF may be used. In such approaches, the beamforming elements are onboard the satellite 62, but the computation of the beamforming solutions is done on the ground. The signal to be transmitted from each beamforming antenna of the satellite 62 is generated on the ground, with all such signals then multiplexed onto an uplink channel, and de-multiplexed at the satellite 62, for transmission from the corresponding antennas/antenna elements.

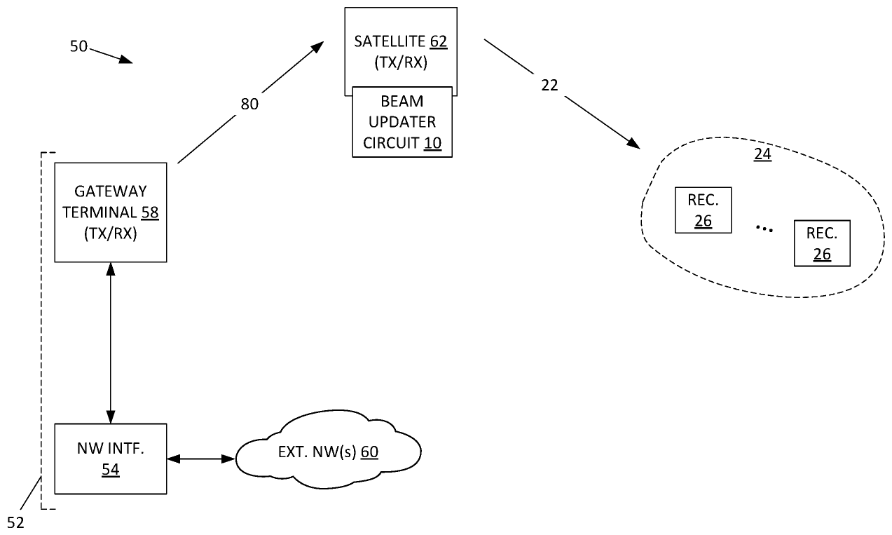

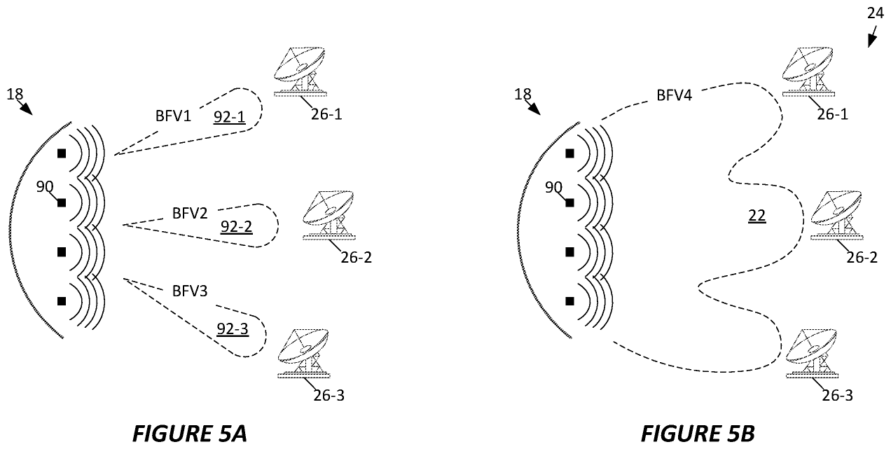

FIGS. 5A and 5B aid a further understanding of beamforming according to one or more example embodiments. A transmission system 18 according to the example includes multiple antenna elements 90, for use in transmitting a beam signal 28 using per-antenna weightings. For simplicity, the figures omit any filtering, frequency translation, power amplification, or other transmit-path operations that may be applied to the beam signal 28.

FIG. 5A illustrates three receivers 26-1, 26-2, and 26-3. Taking each receiver 26 in isolation, there is a unicast beamforming vector that will concentrate transmitted radiation towards the receiver 26 and minimize transmitted radiation in other directions. As an illustration, transmitting antenna-weighted versions of a same signal from the antenna elements 90 according to BFV1 results in the far-field radiation pattern denoted as beam 92-1, transmitting antenna-weighted versions of a same signal from the antenna elements 90 according to BFV2 results in the far-field radiation pattern denoted as beam 92-2, and transmitting antenna-weighted versions of the a signal from the antenna elements 90 according to BFV3 results in the far-field radiation pattern denoted as beam 92-3.

The transmission system 18 does not necessarily perform the unicast beamforming depicted in FIG. 5A, but it provides an example basis for initially configuring a BFV 16 to be used for beamforming a beam signal 28, for a population 24 of receivers 26. Each of BFV1, BFV2, and BFV3 may be computed, for example, on a matched-filter basis, using channel estimates determined by or for the respective receiver 26-1, 26-2, or 26-3. For example, the estimated transmission channel to the receiver 26-1 is a vector h₁ of channel coefficients relating each transmit antenna 90 to the receiver 26-1. Along the same lines, the estimated transmission channel to the receiver 26-2 is the vector h₂, and the estimated transmission channel to the receiver 26-3 is the vector h₃.

On a matched-filter basis, BFV1 for the receiver 26-1 is given as b₁=h₁^{H}, where the “H” is the Hermitian operator, BFV2 for the receiver 26-2 is given as b₂=h₂^{H}, and BFV3 for the receiver 26-3 is given as b₃=h₃^{H}.

The three beamforming vectors BFV1, BFV2, and BFV3, may be combined, to form a resulting vector that is the superposition of BFV1, BFV2, and BFV3. Thus, BFV4 may be expressed as b=Σₖ₌₁^{K}bₖ=Σₖ₌₁^{K}hₖ^{H}, where k=1 to 3 in this example. BFV4 may then serve at least as the initial beamforming vector for the population, which then may be adapted on a recurring or triggered basis, according to the IUP 12. See FIG. 5B.

Thus, in one or more embodiments, the beam updater circuit 10 initializes a BFV 16 for a population 24 of receivers 26 as the superposition of the per-receiver matched-filter BFVs computed for some or all of the receivers 26 in the population 24. However, the initial BFV 16 may or may not be used for actual signal transmission. For example, when there is a single population 24 of receivers 26, the beam updater circuit 10 may compute the initial BFV 16 and apply it—i.e., cause the transmission system 18 to transmit a beam signal 28 for the population 24 according to the initial BFV 16. Then the beam updater circuit 10 recomputes the BFV 16 according to the IUP 12 and applies the updated version of the BFV 16 to actual transmit-signal beamforming upon completion of the IUP 12.

In other scenarios, such as where there are two or more populations 24 of receivers 26 to be served concurrently, the beam updater circuit 10 may use the above matched-filter superposition technique to compute an initial BFV 16 for each population 24 of receivers 26, but not apply those initial BFVs 16. Instead, the beam updater circuit 10 performs the IUP 12 to obtain a BFS 14 comprising BFVs 16 that are computed for the respective populations 24 in consideration of mutual interference between the respective beamformed signals 22.

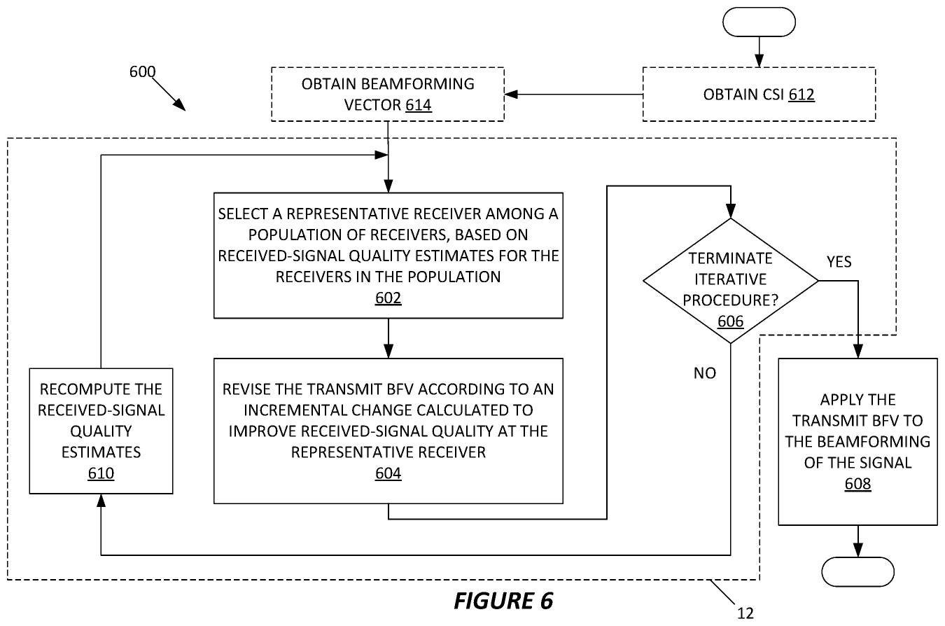

FIG. 6 illustrates a method 600 according to one embodiment, representing example steps or operations performed by or for a transmission system 18. The method 600 comprises revising a transmit beamforming vector—a BFV 16—according to an IUP 12, for multi-lobe beamforming of a signal 28 for a population 24 of receivers 26.

The IUP 12 comprises:
selecting (Block 602) a representative receiver 26 among the population 24 of receivers 26, based on received-signal quality estimates for the receivers 26 in the population 24, the received-signal quality estimates dependent upon the transmit beamforming vector;
revising (Block 604) the transmit beamforming vector, according to an incremental change that is calculated to improve received-signal quality at the representative receiver 26; and
terminating (Block 606) the IUP 12 responsive to fulfillment of a termination condition.

The termination condition in one or more embodiments is the earlier of a limit on the number of iterations or detection of a convergence condition. The convergence condition is detected, for example, by assessing the incremental changes being made to the BFV 16 over two or more iterations of the IUP 12.

After termination of the IUP 12, the method 600 continues with applying (Block 608) the transmit beamforming vector to the beamforming of the beam signal 28 targeted to the population 24 of receivers 26. Here, “applying” refers to the beam updater circuit 10 causing the involved transmission system 18 to use the transmit beamforming vector to the transmission of the beam signal 28 from multiple antenna elements, to produce a corresponding beamformed signal 22 in the far field for the population 24 of receivers 26. In at least one embodiment, the beam updater circuit 10 applies the transmit beamforming vector by sending signaling that causes the beamforming system 20 to apply the beamforming weights comprised in the transmit beamforming vector, to transmission of the beam signal 28.

The method 600 may be performed as an initial operation to determine the transmit beamforming vector before any transmission of the beam signal 28. The method 600 also may be repeated periodically or from time to time, e.g., on a triggered basis. Performance of the IUP 12 may be preceded by obtaining (Block 612) CSI for the population 24 of receivers 26 and obtaining an initial value of the transmit beamforming vector (Block 614). Obtaining the initial value of the transmit beamforming vector comprises, for example, computing an initial or starting beamforming vector, calculated from the CSI, or using arbitrary values. Or the IUP 12 may be used to update the transmit beamforming vector computed by a prior run of the IUP 12.

Performance of the IUP 12 may be preceded by obtaining (Block 614) CSI for the population 24 of receivers 26. As noted, the CSI may be fed back from individual receivers 26 in the population 24, or the beam updater circuit 10 may generate the CSI, e.g., based on knowing the locations of the receivers 26. The CSI may include the received-signal quality estimates for the individual receivers 26 in the population 24, or the beam updater circuit 10 may compute the received-signal quality estimates from the CSI, for entry into the IUP 12.

As seen in the flow diagram, for each next iteration of the IUP 12, the received-signal quality estimates are recomputed (or newly received from the receivers 26), to reflect the incremental update made to the transmit beamforming vector in each current iteration (Block 610). These changes in the received-signal quality estimates for the individual receivers 26 in the population 24 mean that representative receiver 26 selected in a next iteration of the IUP 12 is not necessarily the same receiver 26 selected in the prior iteration.

One way to understand the changing received-signal quality estimates is to appreciate that the transmit beamforming vector used to beamform the beam signal 28 for the population 24 of receivers 26 has a direction in a corresponding vector space. The transmission channel to each receiver 26 in the population 24 can be represented as a channel vector in the same vector space. The received-signal quality at any particular one of the receivers 26 in the population 24 depends on the angle between the transmit beamforming vector and the channel vector of that particular receiver 26. The incremental change made to the transmit beamforming vector in each iteration of the IUP 12 can be understood as incrementally changing the direction of the beamforming vector, which correspondingly changes the beamforming-vector-to-channel-vector angle for each of the receivers 26 in the population 24.

To the extent that the change reduces the angle between the beamforming vector and the channel vector of any given receiver 26 in the population 24, the received-signal quality estimate for that receiver 26 improves incrementally. Conversely, to the extent that the change increases the angle between the beamforming vector and the channel vector of any given receiver 26 in the population 24, the received-signal quality estimate for that receiver 26 decreases incrementally.

Broadly, the IUP 12 may be applied to a transmit beamforming vector in its initialized state, where it may not have yet been applied as a “live” value in transmit-signal beamforming, or it may be used to update a transmit beamforming vector determined by previous performance of the IUP 12. In this latter case, the current “live” value of the transmit beamforming vector being used for transmit signal beamforming may be maintained for ongoing beamforming, while a copy of the live value is processed in the IUP 12 and then applied as the new live value for transmit-signal beamforming upon completion of the IUP 12. Alternatively, the live value being applied in ongoing transmit-signal beamforming is manipulated directly in the IUP 12, meaning that the beamforming applied to signal transmission changes with each iteration of the iterative update procedure.

Thus, regarding block 602 of the method 600, it will be appreciated that saying that the received-signal quality estimates depend upon the transmit beamforming vector means a dependence in the sense that the actual transmit-signal beamforming changes and thus affects the measured signal quality at the receivers, or a dependence in the analytical sense—i.e., the signal-quality estimates are determined computationally, according to the iteratively updated values of the transmit beamforming vector as processed within the IUP 12.

Thus in a first example variation of the method 600, the method steps can be expressed as (1) get channel state information, (2) get measured SNRs from the receivers or calculate SNRs from the channel state information, (3) select the representative receiver(s), (4) make a small adaptation to transmit beamforming vector, (5) apply the transmit beamforming vector, as just adapted, to ongoing transmit-signal beamforming, and (6) repeat steps 1-5 until convergence or satisfaction of another termination condition. Another example variation of the method 600 includes the following method step: (1) get channel state information, (2) calculate SNRs from the channel state information, (3) select the representative receiver(s), (4) make a small adaptation to the transmit beamforming vector, (5) repeat steps 1-4 until convergence or satisfaction of another termination condition, and (6) apply the transmit beamforming vector, e.g., replace the current value of the transmit beamforming vector in actual use for transmit-signal beamforming with the adapted version yielded by the iterative update procedure.

The difference between the two variations is in the inversion of steps 5 and 6. That is, one approach makes a small adaptation, applies the change to actual transmit-signal beamforming, and evaluates the results in terms of measured SNRs at the receivers, with that process repeated. In the other approach, the incremental adaptation is not actually applied but the theoretical results of the iterative changes are computed as if it had been applied. After the final iteration, the finally-adapted value of the transmit beamforming vector is applied.

FIG. 7 illustrates an example vector space having a dimensionality that depends on the number of transmit antennas used for beamforming. For simplicity, FIG. 7 assumes two transmit antennas and one receiver antenna and line-of-sight (LoS) transmission, thus yielding a two-dimensional vector space for a beamforming vector b. With two transmit antennas used for beamforming a beam signal 28 for a population 24 of receivers 26, the beamforming vector b=[w1, w2]^{H}, where w1 is the antenna weight for antenna 1 and w2 is the antenna weight for antenna 2. Correspondingly, the transmission channel h for any given receiver 26 in the population 24 is h=[c1, c2], where c1 represents the channel with respect to antenna 1 and c2 represents the channel with respect to antenna 2. Two transmit antennas is merely an example; more transmit antennas may be used.

The end-to-end signal gain y for a given receiver 26 in the population 24 is given by the inner product of the channel coefficients c for the receiver 26 and the beamforming weights w, e.g., y=(h₁b₁+h₂b₂)s, where “s” corresponds to the beam signal 28 to be transmitted for the population 24 of receivers 26 according to the beamforming vector. If the beamforming vector has unit norm, the beamformer gain may be visualized as the projection of the channel vector onto the beamforming vector.

FIG. 8 expands on the example of FIG. 7 by depicting a scenario involving two receivers 26. P1 denotes the projection of the channel vector for a first receiver 26 on a transmit beamforming vector. P2 denotes the projection of the channel vector for a second receiver 26 on the transmit beamforming vector. “BFV′” in the diagram represents the transmit beamforming vector after an incremental adjustment. Correspondingly, P1′ denotes the updated projection for the first receiver 26 and P2′ denotes the updated projection for the second receiver 26. Note that before the adaptation, the user with channel h1 has a high gain P1 (strong user) while the user with channel h2 has a low gain P3 (weak user). After the adaptation, the gain of the weak user P2′ is increased at the expense of the gain of the strong user P1′.

The second receiver 26 is “weaker” than the first receiver 26, according to their respective vector projections P2′ and P1′. These vector projections represent one example of the received-signal quality estimates used by the beam updater circuit 10, to choose a representative receiver 26 in each iteration of the IUP 12. For example, in one or more embodiments, in each iteration of the IUP 12, the beam updater circuit 10 chooses the “weakest” receiver 26 in a population 24 of receivers 26 as the representative receiver 26 for that population 24. Comparing the respective vector projections of the receivers 26 in the population provides the basis for identifying the weakest receiver 26 as the receiver 26 having the smallest vector projection.

FIG. 9 depicts an example of the “incremental change” made to a transmit beamforming vector in one iteration of the IUP 12. The example applies in a scenario where there is only one population 24 of receivers 26, rather than two or more populations 24, which would generally involve a more complex, joint adaptation of the respective transmit beamforming vectors.

The vector h in FIG. 9 is the channel vector of the representative receiver 26 selected for the population 24 of receivers 26, the vector b is the current value of the transmit beamforming vector for the population 24, and Δb is a change vector calculated to move the vector b into greater alignment with the vector h. The combined vector b+Δb represents the changed or updated version of the vector b. In the example of FIG. 9, the change vector Δb is a scaled down version of the vector h.

In one or more embodiments, the IUP 12 includes operations performed to reconcile the updated beamforming vector with transmission power limits. For example, revising the transmit beamforming vector in each iteration of the IUP 12 includes normalizing the transmit beamforming vector responsive to determining that applying the transmit beamforming vector, as revised according to the incremental change, would result in exceeding a maximum transmit power. Referring back to the example of FIG. 9, each iteration of the IUP 12 includes, in at least one embodiment, determining whether the use of b+Δb for beamforming of the beam signal 28 would result in exceeding a transmit power limit. If so, b+Δb is adjusted.

Turning back to the method 600, obtaining CSI for the receivers 26 in the population 24 comprises, for example, receiving reported CSI from respective ones of the receivers 26 in the population 24. In another example, obtaining the CSI comprises determining it based on channel modeling utilizing the geographic positions of the receivers 26 in the population 24. Particularly, the channel modeling is based on the receiver locations relative to the transmit antennas used for transmit beamforming.

The CSI comprises channel estimates, each channel estimate estimating a transmission channel between the transmitter and a corresponding one of the receivers 26 in the population 24. The channel estimates are static with respect to performing the IUP 12 in one or more embodiments. In such embodiments, the IUP 12 relies on the same receiver channel estimates for all iterations, although the received-signal quality estimates change in each iteration as a function of the incremental change made to the transmit beamforming vector in each iteration. The received-signal quality estimates may be computed analytically by the beam updater circuit 10 in each iteration or may be provided to the beam updater circuit 10, such as via feedback from the receivers 26.

In one embodiment, the method 600 is invoked while transmit beamforming is ongoing using a current transmit beamforming vector to perform transmit beamforming of the beam signal 28. The current transmit beamforming vector is then replaced or updated based on the results of the IUP 12. In another embodiment, ongoing transmit beamforming is updated at each iteration of the IUP 12. This approach may be used where received-signal quality estimates used in each iteration are fed back from the receivers 26 rather than computed by the beam updater circuit 10. In each iteration, beamforming of the beam signal 28 changes as a consequence of the incremental update to the transmit beamforming vector, and the receivers 26 provide updated received-signal quality estimates that reflect the incremental update.

In at least one embodiment and with respect to a scenario involving the transmission of a single beam signal 28 for a single population 24 of receivers 26, the incremental change calculated in each iteration of the IUP 12 comprises a change that increases the inner product between the transmit beamforming vector as revised in the prior iteration and a channel vector of the representative receiver 26 selected in each iteration. Viewed another way, in a single-population scenario, the incremental change at each iteration is calculated to improve the SNR at the representative receiver 26. In single-population scenarios, the beam signal 28 being beamformed for the population 24 comprises a “broadcast signal” in the sense that it is common for all receivers 26 in the population 24.

Staying with the single-population example, the problem of transmitting a beam signal 28 for a population 24 of receivers 26 can be formulated as:

$$y = Hx + v , and$$

$$x = bs ,$$

where s is the beam signal 28, b is the transmit beamforming vector, H is the channel matrix for the population 24 of receivers 26, where each row in the channel matrix H is a receiver's channel vector and v represents noise and interference. Identifying the weakest link—the weakest receiver 26 in the population 24 may be formulated as a minimum SINR problem:

$${max}_{b} {SINR}_{min} = {max}_{b} \{ {min}_{k} \frac{{\vert {h}_{k} b \vert}^{2}}{{N}_{0}} \} subject to power constraint {\vert b \vert}^{2} = {P}_{max}$$

An alternative formulation to find the weakest receiver 26 in a population 24 is expressed as a minimum power problem:

$${min}_{b} {\vert b \vert}^{2} subject to {SINR}_{k} = \frac{{\vert {h}_{k} b \vert}^{2}}{{N}_{0}} \geq {SINR}_{min} , k = 1 , … , K for some desired {SINR}_{min}$$

Calculating the incremental change to the transmit beamforming vector in each iteration of the IUP 12 comprises, for example, adapting the beamforming weights comprising the transmit beamforming vector as:

$${b}^{( n + 1 )} = {b}^{n} + μ {h}_{min}^{H} ,$$

where bⁿ is the transmit beamforming vector as it exists in the current iteration before updating, b⁽ⁿ⁺¹⁾ is the transmit beamforming vector after updating, y is the step size, and hₘᵢₙ^{H} is channel vector of the weakest receiver.

As for avoiding maximum transmit power limits, the adapted version of the transmit beamforming vector b⁽ⁿ⁺¹⁾ may be checked by evaluating whether

$${\vert {b}^{( n + 1 )} \vert}^{2} > {P}_{max}$$

where Pₘₐₓ is the transmission power limit to be observed. If the limit is exceeded, the transmit beamforming vector may be normalized as follows:

$${b}^{( n + 1 )} = α {b}^{( n + 1 )} ,$$

$$α = \sqrt{{P}_{max} / {\vert {b}^{( n + 1 )} \vert}^{2}}$$

The method 600 in at least one embodiment includes initializing the transmit beamforming vector as a superposition of respective transmit beamforming vectors individually calculated for some or all of the receivers 26 in the population 24, and subsequently revising the transmit beamforming vector by performing the IUP 12. Refer back to FIGS. 5A and 5B for example details.

The method 600 also applies to scenarios involving concurrent transmit beamforming for more than one population 24 of receivers 26. That is, the population 24 at issue in the method 600 may be one among two or more respective populations 24 of receivers 26. Each respective population 24 is served with a respective beam signal 28 that is beamformed according to a respective transmit beamforming vector.

In such embodiments, the transmission system 18 and the beam updater circuit 10 are configured such that two or more beam signals 28 can be transmitted concurrently, with each beam signal 28 targeted to a respective population 24 among two or more populations 24 of receivers 26.

In scenarios involving concurrent transmission of more than one beam signal 28, the IUP 12 “jointly” updates the respective transmit beamforming vectors corresponding to the respective populations 24, to account for the mutual interference problem between the beam signals 28. Thus, in the multiple-population scenario, step 604 of the method 600 comprises revising each the transmit beamforming vector as one among a plurality of respective beamforming vectors that together form a beamforming solution—e.g., each transmit beamforming vector is one of the BFVs 16 depicted in FIG. 1A or 1B and the set of BFVs 16 constitute a BFS 14. The transmit beamforming vectors are revised jointly in the IUP 12, with each respective transmit beamforming vector used for beamforming a respective beam signal 28 for a respective population 24 of receivers 26.

In the multiple-population scenario, step 602 of the method 600 comprises selecting a representative receiver 26 for each respective population 24. The representative receiver 26 for each respective population 24 is selected on respective received-signal quality estimates for the receivers 26 in the respective population 24. For each population 24, the respective received-signal quality estimates are dependent upon the respective transmit beamforming vector corresponding to that population 24.

In the multiple-population scenario, revising the transmit beamforming vectors in each iteration of the IUP 12 comprises jointly calculating respective incremental changes for the respective transmit beamforming vectors, to account for inter-population interference arising from the concurrent transmission of the respective beam signals 28. Revising the beamforming solution comprises, for example, solving an optimization problem that accounts for mutual interference among the respective signals at the respective representative receivers 26. The optimization problem may be formulated as a gradient descent problem, for example, which depends jointly on channel state estimates of the respective representative receivers 26.

The multiple-population scenario can be formulated using matrix algebra as follows

$$y = Hx + v$$

$$x = Bs$$

where s is a column vector of all the beam signals to be transmitted, B=[b₁, . . . , b_{N}] is a beamforming matrix comprising of N columns, corresponding to the N beamforming vectors for the N populations of receivers and v is the vector of additive noise.
The gradient descent iteration for adapting the beamforming matrix B for the (n+1) iteration is given by

$${B}^{( n + 1 )} = {B}^{( n )} - μ ∇ ( {B}^{( n )} )$$

where μ is a small number indicating a step size parameter and the gradient ∇(B⁽ⁿ⁾) is given by

$$∇ ( {B}^{( n )} ) = {B}^{( n )} ( {H}^{H} H + {σ}_{v}^{2} I ) - {H}^{H}$$

where σᵥ² is the noise variance and I is the identity matrix.

In the multi-population scenario, each respective beam signal 28 is a broadcast signal with respect to the corresponding population 24 of receivers 26. However, because of mutual interference caused by the concurrent transmission of respective beam signals 28 for corresponding populations 24 of receivers 26, this disclosure refers to each beam signal 28 as a “multicasting” signal. Thus, “broadcasting” denotes one population 24 of receivers 26 and “multicasting” denotes two or more populations 24 of receivers 26, with each population 24 served by a different multicasting signal, and with the multicasting signals beamformed according to a BFS 14 that accounts for mutual interference between the multicasting signals in the far field, at the respective populations 24 of receivers 26.

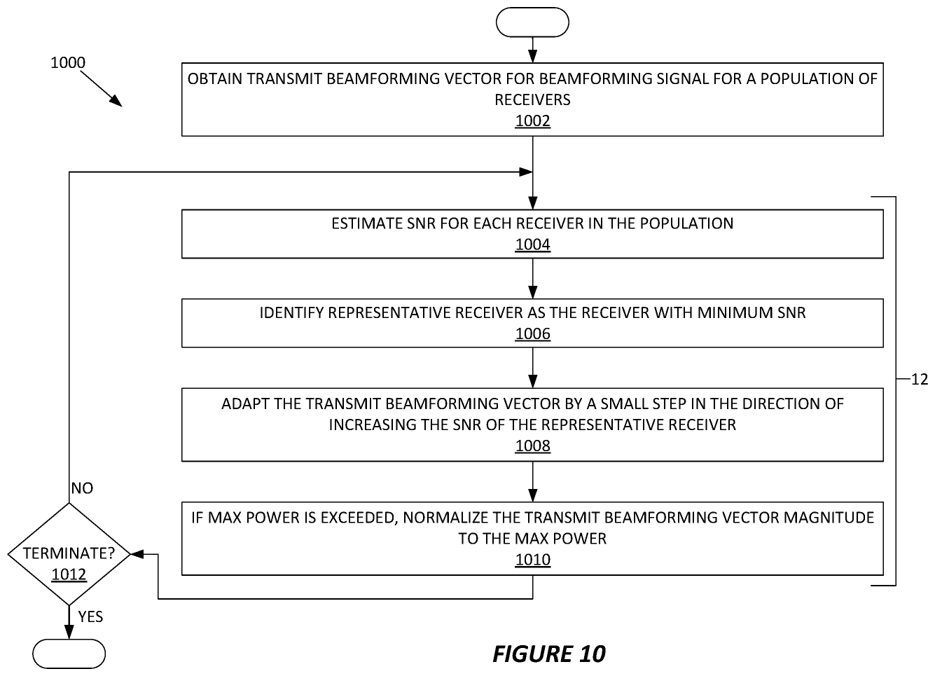

FIG. 10 illustrates a method 1000 that represents a broadcasting scenario—single population 24 of receivers 26—and can be understood as a more detailed example of the method 600 in that context.

The method 1000 includes obtaining (Block 1002) a transmit beamforming vector for beamforming a beam signal 28 for a population 24 of receivers 26. Obtaining comprises initializing the transmit beamforming vector, e.g., as part of an initial run of the method 1000 or to reset the transmit beamforming vector. If transmit beamforming according to the transmit beamforming vector is ongoing, then obtaining the transmit beamforming vector may mean starting the method 1000 with the current value of the transmit beamforming vector as being used for ongoing transmit-signal beamforming.

For the initialization case, the transmit beamforming vector may be initialized with arbitrary weights, for example, or with some combination of unicasting weights, such as shown in FIGS. 5A and 5B. The unicasting weights are, for example, minimum mean square error (MMSE) weights. If the transmit beamforming vector is initialized with non-arbitrary weights, the initialization operations of Block 1002 include, for example, obtaining CSI information for the receivers 26.

Processing continues with estimating (Block 1004) the SNR for each receiver 26 in the population 24 based on the initialized transmit beamforming vector and identifying (Block 1006) the representative receiver 26 as the receiver 26 in the population 24 having the minimum SNR. Here, the SNR values are one example of the received-signal quality estimates referenced in the method 600.

If the beam updater circuit 10 has knowledge of the transmit channel for each receiver 26, then the SNR can be calculated analytically, and the depicted processing loop can be repeated based on analytical recalculation of the SNRs at each iteration of the loop. If the beam updater circuit 10 has only partial knowledge of the transmission channels, e.g., only knows the channel response of the representative receiver 26, then it can interrogate the receivers 26 for new SNR values in each iteration of the loop. In such cases, each iteration depends on having feedback from the receivers 26.

The method 1000 continues with adapting (Block 1008) the transmit beamforming vector by a small step in a direction calculated to increase the SNR of the representative receiver 26. This block corresponds with Block 604 of the method 600, where the incremental change calculated to improve the received-signal quality at the representative receiver is a change to the transmit beamforming vector that increases alignment of the transmit beamforming vector with the channel vector of the representative receiver.

If the adaptation to the transmit beamforming vector would cause a maximum transmit power to be exceeded, the method 1000 includes normalizing (Block 1010) the transmit beamforming vector magnitude to the maximum power. If the termination condition for iteration is not satisfied (NO from Block 1012), the method 1000 continues with a next iteration of the IUP 12. The SNRs estimated in that next iteration are based on the adaptation of the transmit beamforming vector made in the current iteration.

Upon reaching the termination condition (YES from Block 1012), the iterative update process ends. Note that the method 1000 may include applying the transmit beamforming vector—i.e., providing it to the involved transmission system 18/beamforming system 18, for live beamforming of a beam signal 28 for the population 24. For example, beamforming may use the initialized transmit beamforming vector and continue using that vector until a finally-adapted version is produced by completion of the IUP 12. Alternatively, live beamforming may be updated with the incremental adaptation yielded in each iteration of the IUP 12.

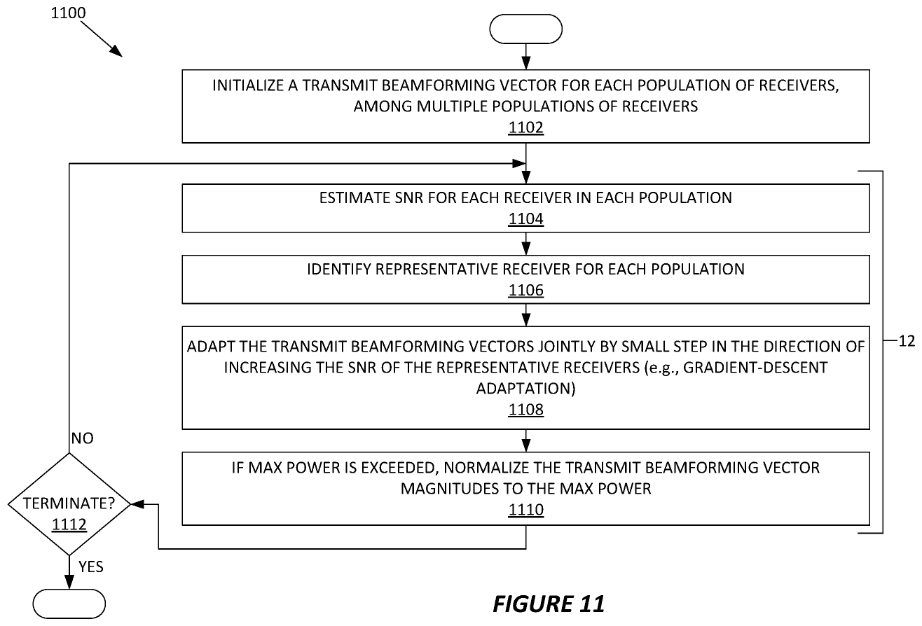

FIG. 11 illustrates a method 1100 that represents a multicasting scenario-two or more populations 24 of receivers 26—and can be understood as a more detailed example of the method 600 in that context.

The method 1100 includes initializing (Block 1102) a transmit beamforming vector for each population 24 of receivers 26, e.g., initializing a BFS 14 comprising a BFV 16 for each population 24. One embodiment of the method 1100 performs the initialization by computing a unicast beamforming vector for each population 24, with the unicast beamforming weights computed with respect to a single selected receiver 26 in each population 24. Here, each unicast beamforming vector can be a matched-filter or MMSE vector computed for the transmit channel of the selected receiver 26 in the corresponding population 24.

The method 1100 continues with estimating (Block 1104) the SNR of each receiver 26 in each population 24, e.g., based on the transmit beamforming vector computed for the population 24 and the channel vector of the receiver 26. Further, the method 1100 includes identifying (Block 1106) a representative receiver 26 for each population 24, e.g., identifying the weakest receiver 26 in each population as the one having the minimum SNR in the population 24.

The method 1100 continues with adapting (Block 1108) the transmit beamforming vectors jointly by a small step in the direction of increasing the SNR of the representative receivers 26. There are as many representative receivers 26 as there are respective populations 24, and there are as many transmit beamforming vectors as there are respective populations 24. Because of the mutual interference between the respective beam signals 28 to be beamformed by the transmit beamforming vectors, the adaptation step accounts for the fact that changing the vector directions of the transmit beamforming vectors influences SNR at the various receivers 26 both in terms of desired-signal gain and interfering-signal gain. For example, the adaptation is a gradient-descent operation that optimizes a cost function expressed in terms of desired-signal gain and interfering-signal gain (Mean Square Error).

If the resulting adaptions of the transmit beamforming vectors would cause a maximum transmit power to be exceeded, the method 1100 includes normalizing (Block 1110) the transmit beamforming vector magnitudes to the maximum power. Further, if the termination conditions(s) are not met (NO from Block 1112), the method 1100 continues with a next iteration of the loop, where the SNR estimations depend on the adaptations of the transmit beamforming vectors made in the current iteration of the loop. If the termination conditions are met (YES from Block 1112), the IUP 12 ends.

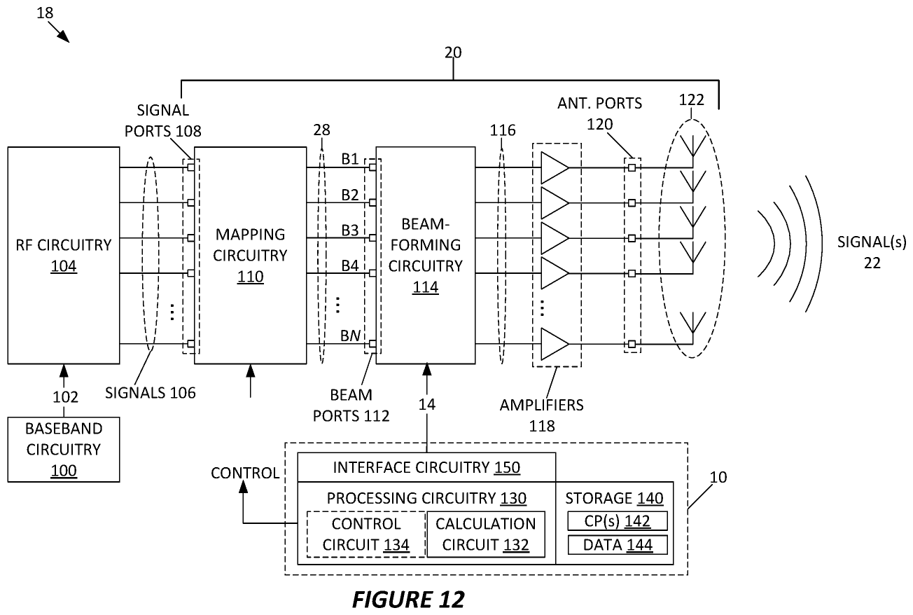

FIG. 12 illustrates another example of a transmission system 18 that includes a beamforming system 20 and a beam updater circuit 10, according to one or more embodiments. The transmission system 18 may be implemented in a single node or distributed among two or more nodes—e.g., a processing node and a transmission node—and may be terrestrial, airborne, or spaceborne.

Baseband circuitry 100 generates one or more signals 102 to be transmitted, and RF circuitry 104 provides modulation and up-conversion of the signals 102, with modulation performed in the digital or analog domain, to obtain one or more signals 106, each corresponding to one of the signals 102. The signals 106 are applied to signal ports 108 of mapping circuitry 110, that maps each signal 106 to a corresponding beam port 112 as a beam signal 28. For each beam signal 28, beamforming circuitry 114 applies a respective BFV 16 included in a BFS 14 provided by the beam updater circuit 10. As such, the signals 116 represent per-element signals, also referred to as antenna-weighted signals, that are amplified by respective ones in a set of power amplifiers 118. The output from each amplifier 118 feeds into a respective one among a set of antenna ports 120 that couple into respective ones among a set of antennas 122 used for transmit beamforming.

The above operations result in each beam signal 28 being transmitted according to a respective BFV 16 provided in the BFS 14 output from the beam updater circuit 10, yielding a corresponding beamformed signal 22 in the far field, for serving a corresponding population 24 of receivers 26. An example arrangement of the beam updater circuit 10 includes circuitry for generating the BFS 14 and applying it.

In the example arrangement, the beam updater circuit 10 comprises processing circuitry 130. The processing circuitry 130 at least functionally includes a calculation circuit 132 that is configured to carry out the IUP 12. In configurations where the beam updater circuit 10 is responsible for controlling the beamforming circuitry 114 and/or the mapping circuitry 110, the beam updater circuit 10 includes corresponding control circuit 134 that outputs one or more control signals, e.g., regarding beam mapping and/or the application of the BFS 14 by the beamforming circuitry 114.

The processing circuitry 130 in at least one embodiment comprises one or more microprocessors or other digital processing circuitry that is specially adapted to carry out beam-updating as disclosed herein based on the execution of computer program instructions, such as may be stored as one or more computer programs (CP(s)) 142 held in storage 140. The storage 140 comprises one or more types of computer-readable media, such as volatile storage, non-volatile storage, or a mix of both. Examples of the storage 140 include any one or more of SRAM, DRAM, NVRAM, EEPROM, FLASH, or Solid State Disk (SSD). The storage 140 may also store short-term or long-term data 144, such as configuration information or information otherwise used by the beam updater circuit 10. In at least one example, the storage 140 holds location information for receivers 26, for channel modeling and corresponding signal-quality estimation.

The beam updater circuit 10 in the example of FIG. 12 further includes interface circuitry 150 that is configured to output an indication of the BFS 14, e.g., signaling that conveys or otherwise identifies the beamforming coefficients for the BFV(s) 16 comprising the BFS 14. Such information may include beam identifiers or other information that controls the beamforming circuitry 114 to apply the correct BFV 16 to the transmission of each beam signal 28. The nature of the interface circuitry 150 depends on whether or what extent the beam updater circuit 10 is co-located or integrated with the beamforming circuitry 114. In the illustrated example, the interface circuitry 150 interfaces directly with the beamforming circuitry 114, e.g., it outputs digital or analog signals directly to corresponding control inputs of the beamforming circuitry 114.

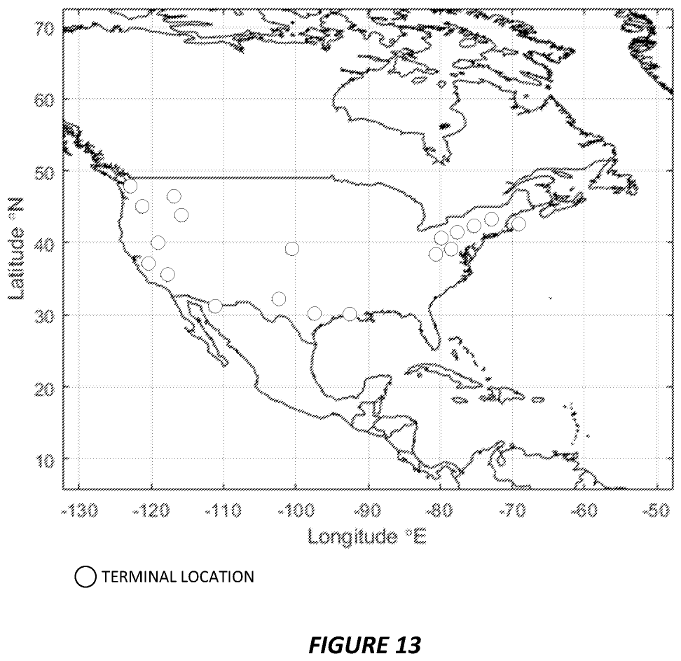

FIG. 13 depicts locations for an example population 24 of receivers 26 and emphasizes the fact that the receivers 26 in the population 24 may be geographically distributed over quite a large region. However, the multi-lobe or group-based beamforming technique embodied in the IUP 12 calculates a BFS 14 that yields a beamformed signal 22 that is shaped with respect to the geographic distribution and addresses the weakest-receiver problem across the population 24. The example of FIG. 13 implies a satellite network where the transmitter is able to illuminate a wide geographic area, in this case encompassing the whole of the United States of America. It should be understood that for other examples of, for instance, terrestrial networks, the distribution of terminals may be in a smaller radius around the base station, than what shown in FIG. 13.

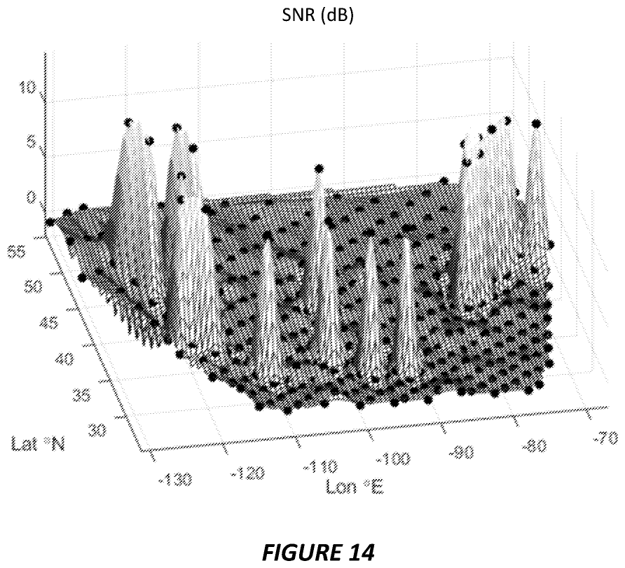

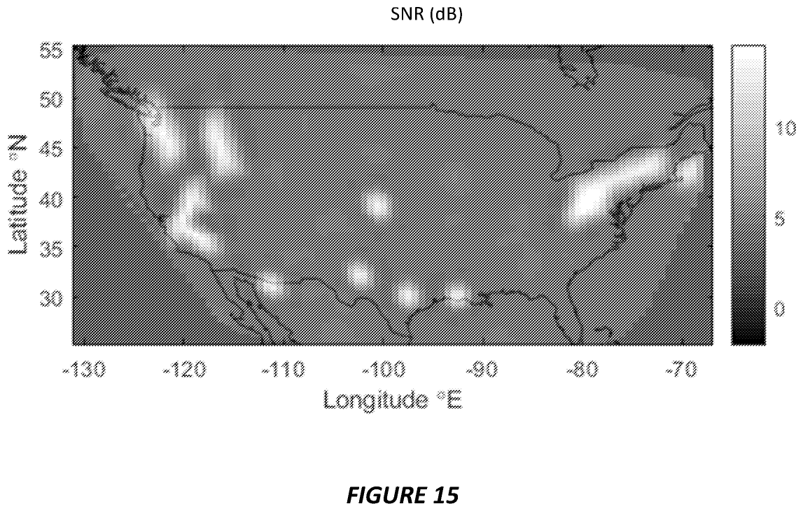

FIG. 14 continues the example scenario of FIG. 13, depicting example SNR values for the respective receivers 26 in the population 24, with respect to their reception of a beamformed signal 22 that multicasts the same beam signal 28 to all receivers 26 in the population 24. Notice the multilobe nature of the radiation pattern, and the fact that the beamformer does not waste transmit power to illuminate areas outside the terminal locations. FIG. 15 continues the same example but offers a “heat map” view of the SNR values.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-48. (canceled)

49. A beam updater circuit comprising:
interface circuitry; and
processing circuitry configured to:
revise a beamforming solution according to an iterative update procedure, wherein the beamforming solution comprises two or more transmit beamforming vectors, each transmit beamforming vector for multi-lobe beamforming of a respective signal for a respective population of receivers, and wherein each iteration comprises:
selecting a representative receiver among each population of receivers, based on received-signal quality estimates for the receivers in the population, the received-signal quality estimates dependent upon the two or more transmit beamforming vectors; and
revising the two or more transmit beamforming vectors, according to an incremental change that is calculated by optimizing received-signal quality and mutual interference at the representative receivers, where the mutual interference is between the respective signals; and
terminate the iterative update procedure responsive to fulfillment of a termination condition; and
apply, via the interface circuitry, each one of the two or more transmit beamforming vectors to beamforming of the respective signal.

50. The beam updater circuit according to claim 49, wherein each iteration further includes normalizing the two or more transmit beamforming vectors responsive to determining that applying the two or more transmit beamforming vectors, as revised according to the incremental change, would result in exceeding a maximum transmit power.

51. The beam updater circuit according to claim 49, wherein the received-signal quality estimates for the receivers in the population change from one iteration to the next, in dependence on the revision made to the two or more transmit beamforming vectors in each iteration, such that the representative receiver selected for each population in a next iteration is not necessarily the same receiver selected for the population in a current iteration.

52. The beam updater circuit according to claim 49, wherein the beam updater circuit is configured to obtain Channel State Information (CSI) for the receivers in each population, and wherein the received-signal quality estimates for the receivers in each population are included in the CSI or calculated by the beam updater circuit in dependence on the CSI.

53. The beam updater circuit according to claim 52, wherein the beam updater circuit is configured to obtain the CSI by one of: receiving reported CSI originating from respective ones of the receivers in each population, or determining the CSI based on channel modeling utilizing the geographic positions of the receivers in each population.

54. The beam updater circuit according to claim 52, wherein the CSI comprises channel estimates, each channel estimate estimating a transmission channel between a corresponding one of the receivers in each population and transmit antennas used for beamforming the respective signals.

55. The beam updater circuit according to claim 54, wherein the channel estimates are static with respect to performing the iterative update procedure.

56. The beam updater circuit according to claim 49, wherein, at least for iterations beyond a first iteration of the iterative update procedure, each iteration further comprises the beam updater circuit calculating the received-signal quality estimates for the receivers in each population, based on the two or more transmit beamforming vectors as revised in the prior iteration and channel vectors relating the receivers in the population to transmit antennas used for beamforming the respective signals.

57. The beam updater circuit according to claim 49, wherein, with respect to revising the beamforming solution according to the iterative update procedure, ongoing beamforming uses copies of the two or more transmit beamforming vectors as they existed before commencement of the iterative update procedure, with the beam updater circuit configured to update the copies after completion of the iterative update procedure.

58. The beam updater circuit according to claim 49, wherein the beam updater circuit is configured to apply the two or more transmit beamforming vectors, as revised in each iteration of the iterative update procedure, to ongoing beamforming of the respective signals.

59. The beam updater circuit according to claim 49, wherein each population of receivers comprises a population of terrestrial terminals served by the respective signal, as relayed by a communications satellite of a satellite communications system.

60. The beam updater circuit according to claim 59, wherein a transmitter that applies the two or more transmit beamforming vectors is on-board the communications satellite.

61. The beam updater circuit according to claim 59, wherein a transmitter that applies to the two or more transmit beamforming vectors is a ground-based transmitter.

62. The beam updater circuit according to claim 49, wherein the beam updater circuit is further configured to initialize each transmit beamforming vector as a superposition of respective transmit beamforming vectors individually calculated for some or all the receivers in the respective population, and subsequently revise the transmit beamforming vector by performing the iterative update procedure.

63. The beam updater circuit according to claim 49, wherein incremental change comprises respective incremental changes for the two or more transmit beamforming vectors.

64. The beam updater circuit according to claim 49, wherein optimizing is based on solving an optimization problem that accounts for mutual interference among the respective signals at the respective representative receivers.

65. The beam updater circuit according to claim 64, wherein the optimization problem is a gradient descent problem that depends jointly on channel state estimates of the respective representative receivers.

66. The beam updater circuit according to claim 49, wherein each respective signal is a multicast signal conveying information common to the receivers in the respective population.
